(19) United States
(12) Patent Application Publication
(10) Pub. No.: US 2017/0212835 A1
(43) Pub. Date: Jul. 27, 2017

(54) COMPUTING SYSTEM WITH MEMORY MANAGEMENT MECHANISM AND METHOD OF OPERATION THEREOF

(71) Applicant: Samsung Electronics Co., Ltd., Suwon-si (KR)

(72) Inventors: Chaohong Hu, San Jose, CA (US); Hongzhong Zheng, Sunnvyale, CA (US)

(21) Appl. No.: 15/098,965

(22) Filed: Apr. 14, 2016

Related U.S. Application Data
(60) Provisional application No. 62/286,212, filed on Jan. 22, 2016.

(51) Int. Cl. G06F 12/08; G06F 12/02

(52) U.S. Cl. CPC G06F 12/0802; G06F 12/0238; G06F 2212/202; G06F 2212/604

(57) ABSTRACT

A computing system includes: a storage component including a volatile-memory device and a non-volatile memory device configured to enable persistent storage of information along with block-oriented mass storage of information; and a controller component, coupled to the storage component, configured to implement a smart memory driver configured to dynamically manage the volatile-memory device including managing a persistent memory (PM) portion, a hardware cache (HWC) portion, a block window (BW) portion, or a combination thereof within the volatile-memory device.

### CROSS-REFERENCE TO RELATED APPLICATION(S)

This application claims the benefit of U.S. Provisional Patent Application Ser. No. 62/286,212 filed Jan. 22, 2016, and the subject matter thereof is incorporated herein by reference thereto.

### TECHNICAL FIELD

An embodiment of the present invention relates generally to a computing system, and more particularly to a system for memory management mechanism.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for more performance while reducing power consumption. Research and development in the existing technologies can take a myriad of different directions.

One such direction includes improvements in managing available resources. As the number of electronic devices and processing power of each device grows, the demand on computing resources is growing exponentially. Efficiently or effectively managing the available resources can provide the increased levels of performance and functionality across multiple devices.

Thus, a need still remains for a computing system with memory management mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a system, including: a storage component including a volatile-memory device and a non-volatile memory device configured to enable persistent storage of information along with block-oriented mass storage of information; and a controller component, coupled to the storage component, configured to implement a smart memory driver configured to dynamically manage the volatile-memory device including managing a persistent memory (PM) portion, a hardware cache (HWC) portion, a block window (BW) portion, or a combination thereof within the volatile-memory device.

An embodiment of the present invention provides a method of operation of a computing system, including: determining a memory requirement for representing a user characteristic, an application characteristic, or a combination thereof; and configuring a volatile-memory device based on balancing a persistent memory (PM) portion, a hardware cache (HWC) portion, and a block window (BW) portion within the volatile-memory device according to the memory requirement, wherein the volatile-memory device is hardware memory for storing information along with a non-volatile memory device, according to a persistent memory (PM) mode, a block mode, or a combination thereof.

An embodiment of the present invention provides a non-transitory computer readable medium including instructions for a computing system, including: determining a memory requirement for representing a user characteristic, an application characteristic, or a combination thereof configuring a volatile-memory device based on balancing a persistent memory (PM) portion, a hardware cache (HWC) portion, and a block window (BW) portion within the volatile-memory device according to the memory requirement, wherein the volatile-memory device is hardware memory for storing information along with a non-volatile memory device, according to a persistent memory (PM) mode, a block mode, or a combination thereof.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an exemplary block diagram of a computing system with memory management mechanism in an embodiment of the present invention.

FIG. 2 is an exemplary architecture diagram of the computing system.

FIG. 3 is an example timing diagram of the storage component of FIG. 2.

FIG. 4 is a flow chart of a method of operation of a computing system in an embodiment of the present invention.

### DETAILED DESCRIPTION

The following embodiments include a NVDIMM P architecture using software to support both a persistent memory mode and a block mode. Existing memory technology can be utilized, such as dynamic random access memory or Flash memory for the following embodiments. The NVDIMM P architecture can be implemented based on a smart memory driver. The following embodiments can further be based on configuring a volatile-memory device to include a persistent memory portion, a hardware cache portion, a block window portion, or a combination thereof along with a non-volatile memory device, a management circuit, a memory data buffer, or a combination thereof.

The following embodiments are described in sufficient detail to enable those skilled in the art to make and use the invention. It is to be understood that other embodiments would be evident based on the present disclosure, and that system, process, architectural, or mechanical changes can be made without departing from the scope of an embodiment of the present invention.

In the following description, numerous specific details are given to provide a thorough understanding of the invention. However, it will be apparent that the invention and various embodiments may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, an embodiment can be operated in any orientation.

The term “component” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a component is written in the apparatus claims section below, the component are deemed to include hardware circuitry for the purposes and the scope of apparatus claims.

The component in the following description of the embodiments can be coupled to one other as described or as shown. The coupling can be direct or indirect without or with, respectively, intervening between coupled items. The coupling can be physical contact or by communication between items.

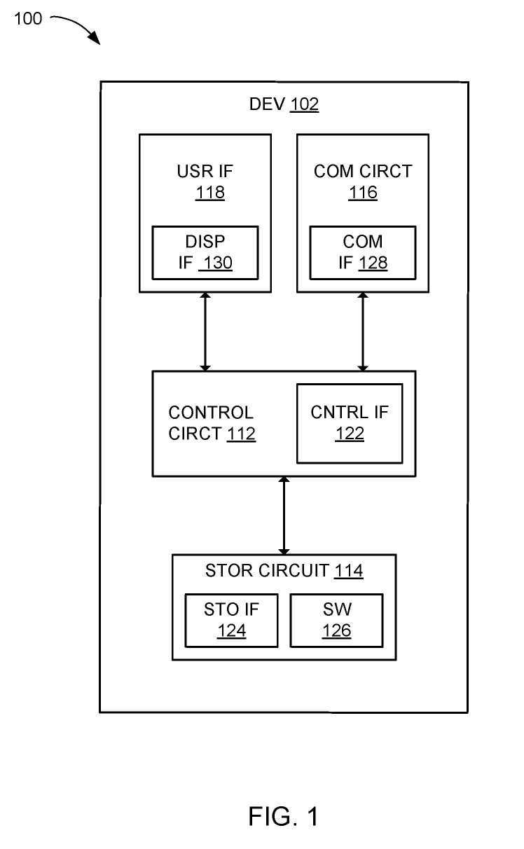

Referring now to FIG. 1, therein is shown an exemplary block diagram of a computing system 100 with thermal mechanism in an embodiment of the present invention. The computing system 100 can include a device 102. The device 102 could be a client device, a server, a display interface, or combination thereof.

For example, the device 102 could be a smart phone, a wearable device or a health monitor, a sensor or a processing device for Internet of Things (IoT), or a combination thereof. Also for example, the device 102 can include a computer, grid computing resources, a virtualized computer resource, cloud computing resource, routers, switches, peer-to-peer distributed computing devices, or a combination thereof. Also for example, the device 102 could be a server utilized by a service provider.

The device 102 can include a control circuit 112, a storage circuit 114, a communication circuit 116, and a user interface 118. The control circuit 112 can include a control interface 122. The control circuit 112 can execute software 126 of the computing system 100.

In an embodiment, the control circuit 112 provides the processing capability and functionality to the computing system 100. The control circuit 112 can be implemented in a number of different manners. For example, the control circuit 112 can be a processor or a portion therein, an application specific integrated circuit (ASIC) an embedded processor, a microprocessor, a central processing unit (CPU), a graphics processing unit (GPU), a hardware control logic, a hardware finite state machine (FSM), a digital signal processor (DSP), a hardware circuit with computing capability, or a combination thereof.

As a further example, various embodiments can be implemented on a single integrated circuit, with components on a daughter card or system board within a system casing, or distributed from system to system across various network topologies, or a combination thereof. Examples of network topologies include personal area network (PAN), local area network (LAN), storage area network (SAN), metropolitan area network (MAN), wide area network (WAN), or a combination thereof.

The control interface 122 can be used for communication between the control circuit 112 and other functional circuit units in the device 102. The control interface 122 can also be used for communication that is external to the device 102.

The control interface 122 can receive information from the other functional circuit units or from external sources, or can transmit information to the other functional circuit units or to external destinations. The external sources and the external destinations refer to sources and destinations external to the device 102.

The control interface 122 can be implemented in different ways and can include different implementations depending on which functional circuit units or external circuit units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage circuit 114 can store the software 126. The storage circuit 114 can also store relevant information, such as data, images, programs, sound files, or a combination thereof. The storage circuit 114 can be sized to provide additional storage capacity.

The storage circuit 114 can be a volatile memory, a nonvolatile memory, an internal memory, an external memory, or a combination thereof. For example, the storage circuit 114 can be a nonvolatile storage such as non-volatile random access memory (NVRAM), Flash memory, disk storage, or a volatile storage such as static random access memory (SRAM), dynamic random access memory (DRAM), any memory technology, or combination thereof.

As a more specific example, the storage circuit 114 can be a non-volatile dual in-line memory module (NVDIMM) including NVDIMM-F utilizing a Flash device that resides on the memory interconnect, NVDIMM-N utilizing a byte-addressable memory-mapped device, or a combination thereof. The NVDIMM-N memory can be an adapted memory module consisting of DRAM made persistent through the use of Flash memory. The NVDIMM-F memory can be based on a further additional Flash memory accessible to the system controller as a block-oriented mass storage device.

The storage circuit 114 can include a storage interface 124. The storage interface 124 can be used for communication with other functional circuit units in the device 102. The storage interface 124 can also be used for communication that is external to the device 102.

The storage interface 124 can receive information from the other functional circuit units or from external sources, or can transmit information to the other functional circuit units or to external destinations. The external sources and the external destinations refer to sources and destinations external to the device 102.

The storage interface 124 can include different implementations depending on which functional circuit units or external circuit units are being interfaced with the storage circuit 114. The storage interface 124 can be implemented with technologies and techniques similar to the implementation of the control interface 122.

For illustrative purposes, the storage circuit 114 is shown as a single element, although it is understood that the storage circuit 114 can be a distribution of storage elements. Also for illustrative purposes, the computing system 100 is shown with the storage circuit 114 as a single hierarchy storage system, although it is understood that the computing system 100 can have the storage circuit 114 in a different configuration. For example, the storage circuit 114 can be formed with different storage technologies forming a memory hierarchal system including different levels of caching, main memory, solid state media, rotating media, or off-line storage.

The communication circuit 116 can enable external communication to and from the device 102. For example, the communication circuit 116 can permit the device 102 to communicate with a second device (not shown), an attachment, such as a peripheral device, a communication path (not shown), or combination thereof.

The communication circuit 116 can also function as a communication hub allowing the device 102 to function as part of the communication path and not limited to be an end point or terminal unit to the communication path. The communication circuit 116 can include active and passive components, such as microelectronics or an antenna, for interaction with the communication path.

The communication circuit 116 can include a communication interface 128. The communication interface 128 can be used for communication between the communication circuit 116 and other functional circuit units in the device 102. The communication interface 128 can receive information from the other functional circuit units or can transmit information to the other functional circuit units.

The communication interface 128 can include different implementations depending on which functional circuit units are being interfaced with the communication circuit 116. The communication interface 128 can be implemented with technologies and techniques similar to the implementation of the control interface 122, the storage interface 124, or combination thereof.

The user interface 118 allows a user (not shown) to interface and interact with the device 102. The user interface 118 can include an input device, an output device, or combination thereof. Examples of the input device of the user interface 118 can include a keypad, a touchpad, soft-keys, a keyboard, a microphone, an infrared sensor for receiving remote signals, other input devices, or any combination thereof to provide data and communication inputs.

The user interface 118 can include a display interface 130. The display interface 130 can include a display, a projector, a video screen, a speaker, or any combination thereof.

The control circuit 112 can operate the user interface 118 to display information generated by the computing system 100. The control circuit 112 can also execute the software 126 for the other functions of the computing system 100. The control circuit 112 can further execute the software 126 for interaction with the communication path via the communication circuit 116.

The device 102 can also be optimized for implementing an embodiment of the computing system 100 in a multiple device embodiment. The device 102 can provide additional or higher performance processing power.

For illustrative purposes, the device 102 is shown partitioned with the user interface 118, the storage circuit 114, the control circuit 112, and the communication circuit 116, although it is understood that the device 102 can have any different partitioning. For example, the software 126 can be partitioned differently such that at least some function can be in the control circuit 112 and the communication circuit 116. Also, the device 102 can include other functional circuit units not shown in for clarity.

The functional circuit units in the device 102 can work individually and independently of the other functional circuit units. For illustrative purposes, the computing system 100 is described by operation of the device 102 although it is understood that the device 102 can operate any of the processes and functions of the computing system 100.

Processes in this application can be hardware implementations, hardware circuitry, or hardware accelerators in the control circuit 112. The processes can also be implemented within the device 102 but outside the control circuit 112.

Processes in this application can be part of the software 126. These processes can also be stored in the storage circuit 114. The control circuit 112 can execute these processes for operating the computing system 100.

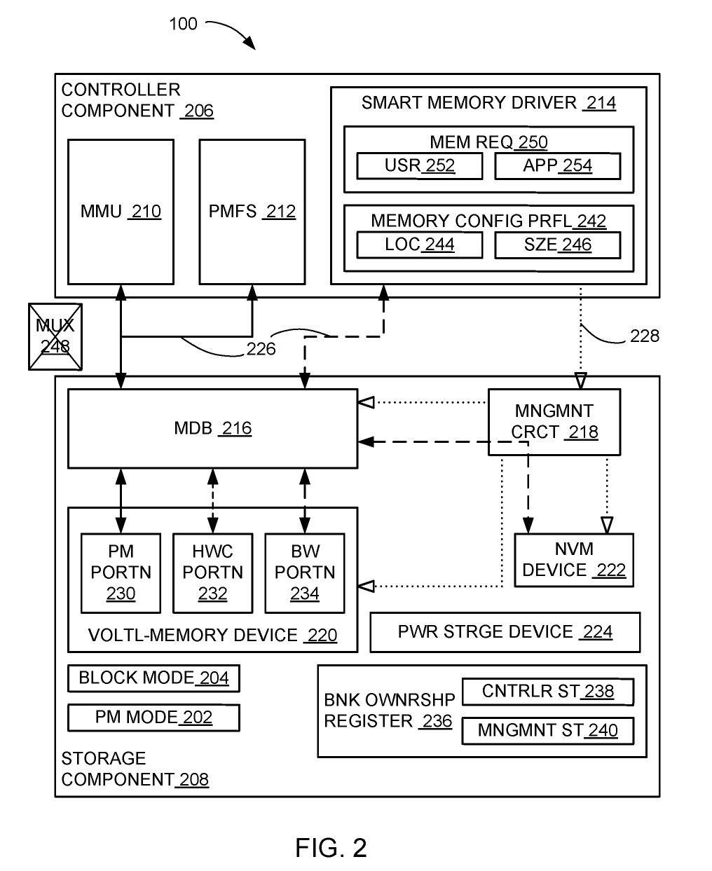

Referring now to FIG. 2, therein is shown an exemplary architecture diagram of the computing system 100. The architecture diagram can represent the storage circuit 114 of FIG. 1, the control circuit 112 of FIG. 1, one or more interfaces thereof, or a combination thereof of the computing system 100.

The computing system 100, as exemplified in the architecture diagram and discussed in detail below, can implement or enable both NVDIMM-F and NVDIMM-N in for the storage circuit 112. For example, the computing system 100 can implement or enable a software defined NVDIMM-P arch to enable the adapted memory module consisting of DRAM made persistent through the use of Flash memory for NVDIMM-N, along with further additional Flash memory accessible to the system controller as a block-oriented mass storage device for NVDIMM-F.

The NVDIMM-N can normally be without system-accessible Flash beyond that needed for persistence functions. The computing system 100 can further use the software defined NVDIMM-P arch to provide the additional Flash functions and effectively provide both NVDIMM-F and NVDIMM-N characteristics. The computing system 100 can use the software defined NVDIMM-P arch to support both a persistent memory (PM) mode 202 and a block mode 204 using the existing memory technology, such as using DRAM and Flash, with the software defined NVDIMM-P arch.

The PM mode 202 is a hardware component or configuration, a method of operation, or a combination thereof for the computing system 100, the storage circuit 114, a portion thereof, or a combination thereof to provide continued access to stored data even after the end of the process that created or last modified them. The PM mode 202 can be associated with NVDIMM-N. The PM mode 202 can enable the computing system 100 to continually access the stored data using memory instructions or a memory application program interface (API).

The PM mode 202 can enable the storage circuit 114 or a portion therein to function as DDR4 memory during normal operation mode. The computing system 100 can use “SAVE” or “STORE” functions for data movement between DRAM and FLASH during power loss or power up operations.

The PM mode 202 can be closely linked to the concept of persistence in its emphasis on program state that exists outside the fault zone of the process that created it to provide memory-like access to data. The PM mode 202 can include DRAM made persistent through the use of Flash memory. The PM mode 202 can be absent further additional Flash memory accessible beyond.

The block mode 204 is a hardware component or configuration, a method of operation, or a combination thereof to provide a block-oriented mass storage device. The block mode 204 can utilize DRAM, Flash memory, or a combination thereof to provide the block-oriented mass storage. The block mode 204 can be associated with NVDIMM-F.

The computing system 100 can utilize a control circuit or SOC to schedule data movement from driver to DRAM, and from DRAM to FLASH during normal operation for the block mode 204. The computing system 100 can use “SAVE” or “STORE” function for data movement between DRAM and FLASH during power loss or power up operations.

The architecture of the computing system 100 for the software defined NVDIMM-P arch can include a controller component 206, a storage component 208, or a combination thereof.

The controller component 206 is configured to control configuration or operation for implementing the software defined NVDIMM-P arch.

The controller component 206 can be implemented as a process, a mechanism, a method, or a combination thereof. The controller component 206 can be part of, included in, implement or execute, or a combination thereof for the software 126 of FIG. 1. The controller component 206 can further be implemented with the control circuit 112, the storage circuit 114, one or more of the interfaces, a portion thereof, or a combination thereof. For example, the controller component 206 can include a memory management unit (MMU) 210, a persistent memory file system (PMFS) 212, or a combination thereof along with a smart memory driver 214.

The memory management unit 210 can include circuitry for translating various addresses, such as between virtual memory addresses and physical addresses. The memory management unit 210 can be hardware. The memory management unit 210 can be part of the control circuit 112, such as for the CPU or a separate integrated circuit, the storage circuit 114, or a combination thereof.

The PMFS 212 can include a file system for persistent memory. The file system can be optimized to be lightweight and efficient in providing access to persistent memory that is directly accessible via the control circuit 112, such as for CPU load instructions, store instructions, or a combination thereof.

The smart memory driver 214 is a process, a mechanism, a method, or a combination thereof for enabling the computing system 100 to communicate with the storage circuit 114, the storage component 208, a portion thereof, or a combination thereof. The smart memory driver 214 can specifically configure and control the storage component 208 for implementing the software defined NVDIMM-P arch.

The smart memory driver 214 can be software, such as included in or similar to the software 126. The smart memory driver 214 can be implemented or executed by the control circuit 112, the storage circuit 114, one or more interfaces therein, or a combination thereof.

The smart memory driver 214 can define or configure one or more regions within the storage component 208 or for a segment therein. The smart memory driver 214 can define or configure the storage component 208 dynamically according to user or application requirements. The smart memory driver 214 can configure the storage component 208 to function as NVDIMM-F, NVDIMM-N, NVDIMM-P, or a combination thereof. The smart memory driver 214 can provide a persistent software framework. The smart memory driver 214 can further replace hardware drivers corresponding to other previous NVDIMM-N-only device or other previous NVDIMM-F-only device.

The storage component 208 is a device, a circuit, a portion thereof, a process or a method associated thereto, or a combination thereof configured to store and provide access to data. The storage component 208 can be dynamically configured to provide or support the PM mode 202, the block mode 204, or a combination thereof. The storage component 208 can emulate NVDIMM-N, NVDIMM-F, or a combination thereof based on the configuration.

The storage component 208 can include hardware memory. The storage component 208 can be a portion or a segment of or within the storage circuit 114. For example, the storage component 208 can include a NVDIMM. Also for example, the storage component 208 can include a DRAM, Flash memory device, other circuitry or buffer associated thereto, or a combination thereof. As a more specific example, the storage component 208 can include a memory data buffer (MDB) 216, a management circuit 218, a volatile-volatile-memory device 220, a non-volatile memory device 222, a power storage device 224, or a combination thereof for enabling persistent storage of information along with block-oriented mass storage of information.

The MDB 216 can be coupled to the volatile-volatile-memory device 220, coupled to the controller component 206 through a memory bus, and coupled to the management circuit 218. The MDB 216 can be coupled to the non-volatile memory device 222 or indirectly coupled to the non-volatile memory device 222 through the management circuit 218. The MDB 216 can be between the controller component 206 and the volatile-volatile-memory device 220, the non-volatile memory device 222, or a combination thereof.

The management circuit 218 can be coupled to the non-volatile memory device 222, coupled to the MDB 216, coupled to the controller component 206 through the memory bus, coupled to the volatile-volatile-memory device 220, or a combination thereof. The management circuit 218 further may be indirectly coupled to the volatile-volatile-memory device 220 through or using the MDB 216. The management circuit 218 can be between the controller component 206 and segments of the storage component 208 designated to store accessible information, such as the MDB 216, the non-volatile memory device 222, the volatile-volatile-memory device 220, or a combination thereof.

The controller component 206 and the storage component 208 can be connected or coupled using the memory bus. The memory bus can be the control interface 122 of FIG. 1, the storage interface 124 of FIG. 1, a portion therein, or a combination thereof. The memory bus can include electrical connections for exchanging data between circuits or components therein.

The memory bus can include one or more data paths 226, one or more control paths 228, a portion thereof, or a combination thereof. The one or more data paths 226 can include one or more electrical connections configured to exchange data or content information targeted or sought by a process, such as information processed or targeted for read or write operations. The one or more data paths 226 are illustrated in FIG. 2 as solid lines with solid arrow, such as for the PM mode 202, a dashed line with coarse dashes, such as for the block mode 204, or a combination thereof.

The one or more control paths 228 can include one or more electrical connections configured to exchange control signals, such as commands or status signals, for implementing a process, such as control or status signals implementing the read or write operations themselves. The control paths 228 are illustrated as finely-dotted lines with white or unfilled arrow heads in FIG. 2.

As exemplified in FIG. 2, all instances of the data paths 226 can be connected to the MDB 216 for the storage component 208. The computing system 100 can be without or absent direct access from the controller component 206 to the volatile-volatile-memory device 220, without direct access to the non-volatile memory device 222, or a combination thereof.

The power storage device 224 can include an energy source for enabling persistent access of the data. The power storage device 224 can include a battery or a capacitor for providing the energy to the storage component 208.

The non-volatile memory device 222 can include a device or circuitry for providing non-volatile memory for processing memory in blocks. The non-volatile memory device 222 can be utilized by reading or writing in units of blocks or pages. The non-volatile memory device 222 can utilize NAND or NOR type components. The non-volatile memory device 222 can provide persistent storage for the PM mode 202, the block mode 204, or a combination thereof.

The volatile-volatile-memory device 220 can include one or more storage circuits that maintain its data while the device is powered. The volatile-volatile-memory device 220 can include a device or circuitry for providing fast or consistent access for data without being affected by physical storage location of the corresponding data or storage location on the device or circuitry. For example, the volatile-volatile-memory device 220 can be implemented as DRAM. As a more specific example, the volatile-volatile-memory device 220 can include DDR4 DRAM utilizing the power storage device 224 to provide data persistence during power loss, such as for NVDIMM-N.

The volatile-volatile-memory device 220 can be dynamically configured to support the PM mode 202, the block mode 204, or a combination thereof. The volatile-volatile-memory device 220 can be dynamically configured to include a persistent memory (PM) portion 230, a hardware cache (HWC) portion 232, a block window (BW) portion 234, or a combination thereof.

The PM portion 230, the HWC portion 232, and the BW portion 234 can each be a portion or a segment within the volatile-memory device 220 configured to store, erase, and provide access to data. The PM portion 230, the HWC portion 232, and the BW portion 234 can be based on a bank-level granularity.

The PM portion 230 is the portion of the volatile-memory device 220 configured to implement the PM mode 202 for continually providing access to data therein after the end of a process creating or processing the data. The PM portion 230 can facilitate NVDIMM-F features for the storage component 208.

The HWC portion 232 is the portion of the volatile-memory device 220 configured to be owned by the management circuit 218 for supporting the non-volatile memory device 222. The HWC portion 232 can work as hardware cache of the non-volatile memory device 222.

The BW portion 234 is the portion of the volatile-memory device 220 configured to provide an interface for the non-volatile memory device 222. The BW portion 234 can work as a Block Window interface utilized in accessing the blocks of memory corresponding to the non-volatile memory device 222.

The volatile-memory device 220 can include the PM portion 230, the HWC portion 232, the BW portion 234, or a combination thereof according to configurations determined dynamically using software, instead of a configuration preset or predetermined in hardware by a factory or manufacturer setting. For example, the dynamic configuration can determine the existence, physical size, physical location, or a combination thereof for the PM portion 230, the HWC portion 232, the BW portion 234, or a combination thereof.

Also for example, the PM portion 230, the HWC portion 232, the BW portion 234, or a combination thereof can include one or more banks of the volatile-memory device 220 for a bank-level granularity. Details regarding the dynamic configuration are discussed in detail below.

The MDB 216 is configured to temporarily store data in accommodating or implementing the PM mode 202, the block mode 204, or a combination thereof. The MDB 216 can include physical memory storage used to temporarily store data between the memory bus, the volatile-memory device 220, the management circuit 218, the non-volatile memory device 222, or a combination thereof. The MDB 216 can be configured to manage data exchange between the volatile-memory device 220, the non-volatile memory device 222, the controller component 206, or a combination thereof. The MDB 216 can also be configured to manage control signals or functions for the management circuit 218, the controller component 206, or a combination thereof.

The management circuit 218 is configured to control the volatile-memory device 220, the non-volatile memory device 222, or a combination thereof for performing the storage or the access function for the information therein. The management circuit 218 can be implemented as system on chip (SOC). The management circuit 218 can control the volatile-memory device 220 and/or the non-volatile memory device 222, according to commands or instructions, such as write or read, from the controller component 206.

For example, the management circuit 218 can control or provide the DDR4 registered clock driver function for the volatile-memory device 220. Also for example, the management circuit 218 can be a Flash controller for the non-volatile memory device 222. Also for example, the management circuit 218 can control or implement data movement or scheduling thereof between the volatile-memory device 220 and the non-volatile memory device 222, such as using software controlled ownership states discussed below. Also for example, the management circuit 218 can control using a combination of the examples discussed above or other methods or processes.

The management circuit 218 can support the PM mode 202, the block mode 204, or a combination thereof with smart data and control flow. For example, the management circuit 218 can control the storage component 208 to work as DDR4 memory or as NVDIMM-N in the PM mode 202 during normal operation. For power-loss or power-up conditions, the management circuit 218 can use “SAVE” or “STORE” function for data movement between the volatile-memory device 220 and the non-volatile memory device 222.

Also for example, the management circuit 218 can schedule data movement from the smart memory driver 214 to the volatile-memory device 220, and from the volatile-memory device 220 to the non-volatile memory device 222 for the block mode 204 during normal operation. Within the volatile-memory device 220, the data movement can include the data transitioning from the BW portion 234 to the HWC portion 232 and then to the non-volatile memory device 222. The data movement can be based on the bank-level granularity of the volatile-memory device 220. The management circuit 218 can further “SAVE” or “STORE” function for data movement between the volatile-memory device 220 and the non-volatile memory device 222 for power-loss or power-up conditions.

Also for example, the management circuit 218 can resolve a timing issue for the volatile-memory device 220, or the DRAM timing issue wherein the management circuit 218 and the memory controller 210 for the controller component 206 observe different DRAM timing parameters. Details regarding the timing issue will be discussed below. Also for example, the management circuit 218 can support the PM mode 202, the block mode 204, or a combination thereof using a combination of processes or methods discussed above or other methods or processes.

The computing system 100 can further include a bank ownership register 236. The bank ownership register 236 is a status or control mechanism or circuit for supporting the PM mode 202, the block mode 204, or a combination thereof. The bank ownership register 236 can be on or included in the storage circuit 114, such as the NVDIMM. The bank ownership register 236 can be set by the controller component 206, the memory controller, or a combination thereof.

The bank ownership register 236 can include a circuitry or mechanism for indicating process or data ownership of one or more circuits, components, devices, software, or a combination thereof within the computing system 100. The bank ownership register 236 can be used to provide control for data stored in the volatile-memory device 220 to the controller component 206 or the storage component 208.

For example, the bank ownership register 236 can control or indicate a controller-ownership state 238, a management-ownership state 240, or a combination thereof. The controller-ownership state 238 is a memory management or control configuration with the software, the smart memory driver 214, the memory controller, or a combination thereof owning one or more target bank of the volatile-memory device 220. The management-ownership state 240 is a memory management or control configuration with the memory controller 210 owning the one or more target bank of the volatile-memory device 220. Details regarding the ownership states will be discussed below.

The computing system 100 can include the storage component 208 configured to utilize the MDB 216, the management circuit 218, or a combination thereof to provide access to the volatile-memory device 220 without or instead of a multiplexer 248. The storage component 208 can utilize the MDB 216, the management circuit 218, or a combination thereof to provide access without any direct access to the DRAM through the multiplexer 248 utilized in other types of devices.

The multiplexer 248 can include a device configured to select one of several input signals and output the selected signal. The multiplexer 248 can be used to provide selection of a signal, a path, or an access from a set of possible selections or choices.

The computing system 100 can utilize the functional circuits or blocks discussed above to dynamically configure the storage component 208, enable or support the PM mode 202 or the block mode 204 or both, manage or implement memory operations accordingly, or a combination thereof. The computing system 100 can include the controller component 206 further configured to implement the smart memory driver 214 to dynamically configuring the volatile-memory device 220 to enabling the persistent storage of information according to user, application, or a combination thereof.

The controller component 206 can dynamically configure the volatile-memory device 220 to include the PM portion 230, the HWC portion 232, the BW portion 234, or a combination thereof. The controller component 206, with the smart memory driver 214, can generate a memory configuration profile 242 including a portion location 244, a portion size 246, or a combination thereof for dynamic configuration.

The memory configuration profile 242 is a description for details regarding one or more portions within the volatile-memory device 220. The memory configuration profile 242 can describe or control a size or capacity, a physical location, or a combination thereof of the one or more portions, such as the PM portion 230, the HWC portion 232, the BW portion 234, or a combination thereof.

The portion location 244 is a description of a physical location on the volatile-memory device 220 for the corresponding portion such as for the PM portion 230, the HWC portion 232, the BW portion 234, or a combination thereof. The portion size 246 is the size or capacity of the corresponding portion.

The controller component 206 can generate the memory configuration profile 242 according a memory requirement 250 for representing a user characteristic 252 of the user, an application characteristic 254 of the application or software, or a combination thereof. The memory requirement 250 is a representation of demand or necessity for storing or accessing information using the storage component 208. The memory requirement 250 can be determined based on a user characteristic 252, the application characteristic 254, or a combination thereof.

The user characteristic 252 can include a trait or a pattern associated with the user using the computing system 100. The user characteristic 252 can include a usage pattern, a preference or setting of or from the user, a representation thereof, or a combination thereof.

The computing system 100 can determine the user characteristic 252 in a variety of ways. For example, the computing system 100 can use the smart memory driver 214 or the software 126 to determine the user characteristic 252 by recording usage or access information corresponding to the user.

Also for example, the computing system 100 can interact with the user through the user interface to determine any preference or setting information. Also for example, the computing system 100 can determine the user characteristic 252 based on pattern recognition mechanisms, machine-learning mechanisms, or a combination thereof. Also for example, the computing system 100 can determine the user characteristic 252 using a combination of processes or methods discussed above or other processes or methods.

The application characteristic 254 can include user applications or software packages stored or enabled on the computing system 100. The application characteristic 254 can be similar to the user characteristic 252 but for the user applications or software packages. The application characteristic 254 can describe or represent one or more instances of the software 126, a portion thereof, or a combination thereof. For example, the application characteristic 254 can be based on a size, a performance or runtime requirement or demand, or a combination thereof for the user applications or software packages.

The computing system 100 can determine the application characteristic 254 in a variety of ways. For example, the computing system 100 can use the smart memory driver 214 or the software 126 to determine the application characteristic 254 by analyzing the user applications or software packages themselves, metadata thereof, or a combination thereof. Also for example, the computing system 100 can determine the application characteristic 254 based on accessing information or descriptions of the user applications or software packages stored or enabled thereon from the software, its provider or distributer.

The computing system 100 can determine the memory requirement 250 dynamically based on on-going usage of the computing device 100. The computing system 100 can further determine the memory requirement 250 dynamically based on a current state or configuration associated with the user applications or software packages on the computing system 100 or being accessed in real-time.

The computing system 100 can further generate the memory configuration profile 242 based on the memory requirement 250. For example, the computing system 100 can generate the memory configuration profile 242 during runtime, such as based on initiation or execution of an application or usage. Also for example, the computing system 100 can generate the memory configuration profile 242 at start-up or initiation, as part of shut down or reset, or a combination thereof.

Also for example, the computing system 100 can generate the memory configuration profile 242 using the smart memory driver 214 implemented in software. The computing system 100 can generate the memory configuration profile 242 by specifying or allocating a size, a location, a priority, or a combination thereof within the volatile-memory device 220 dedicated to one or more portions supporting the block mode 204, the PM mode 202, or a combination thereof.

The computing system 100 can generate the memory configuration profile 242 for setting or designating the PM portion 230, the HWC portion 232, the BW portion 234, or a combination thereof in the volatile-memory device 220. The computing system 100 can generate the memory configuration profile 242 including the portion location 244, the portion size 246, or a combination thereof corresponding to the PM portion 230, the HWC portion 232, the BW portion 234, or a combination thereof.

For example, the controller component 206 can increase the BW portion 234, the HWC portion 232, or a combination thereof for enabling or increasing usage or implementation of the non-volatile memory device 222, the block mode 204, NVDIMM-F feature or function, or a combination thereof. Also for example, the controller component 206 can increase the PM portion 230 for enabling or increasing usage or implementation of the volatile-memory device 220, the PM mode 202, NVDIMM-N feature or function, or a combination thereof.

As a more specific example, the controller component 206 can generate the memory configuration profile 242 for controlling a size or capacity, a physical location, or a combination thereof for configuring or setting the BW portion 234, the HWC portion 232, the PM portion 230, or a combination thereof within the volatile-memory device 220. The controller component 206 can generate the memory configuration profile 242 describing or designating specific instances of one or more banks of the volatile-memory device 220 as the BW portion 234, the HWC portion 232, the PM portion 230, or a combination thereof according to the memory requirement 250.

The computing system 100 can further access, update, adjust, or a combination thereof, the memory configuration profile 242. The computing system 100 can process the memory requirement 250, the memory configuration profile 242, or a combination thereof using the controller component 206, the smart memory driver 214, the management circuit 218, the storage component 208, the control circuit 112, the storage circuit 114, or a combination thereof.

The controller component 206, the management circuit 218, or a combination thereof can dynamically implement the memory configuration profile 242 or configure the volatile-memory device 220 for implementing or enabling the PM mode 202, the block mode 204, or a combination thereof. The volatile-memory device 220 can be dynamically configured by setting or designating the BW portion 234, the HWC portion 232, the PM portion 230, or a combination thereof according to the memory configuration profile 242.

The volatile-memory device 220 can be dynamically configured according to the portion location 244, the portion size 246, or a combination thereof corresponding to, describing, or controlling the BW portion 234, the HWC portion 232, the PM portion 230, or a combination thereof. The volatile-memory device 220 can further be configured based on the memory configuration profile 242 by defining within the volatile-memory device 220 the PM portion 230, the HWC portion 232, the BW portion 234, or a combination thereof according to the portion location 244, the portion size 246, or a combination thereof corresponding thereto. The volatile-memory device 220 can be configured based on designating one or more specific instances of the banks according to the portion location 244, the portion size 246, or a combination thereof as the BW portion 234, the HWC portion 232, or the PM portion 230 corresponding thereto.

The volatile-memory device 220 can be hardware memory for storing information along with the non-volatile memory device 222 according to the PM mode 202, the block mode 204, or a combination thereof. The volatile-memory device 220 can be configured based on balancing the PM portion 230, the HWC portion 232, and the BW portion 234 within the volatile-memory device 220 according to the memory requirement 250. The volatile-memory device 220 can be balanced by varying sizes or locations for the PM portion 230, the HWC portion 232, the BW portion 234, or a combination thereof according to a need, a requirement, an estimate thereof, or a combination thereof for the computing system 100.

As a more specific example, the volatile-memory device 220 can be configured to include the BW portion 234. The BW portion 234 can be dynamically configured. The BW portion 234 can provide indirect access from the controller component 206 to the non-volatile memory device 222. The BW portion 234 can provide the indirect access through the direct access of the volatile-memory device 220.

Also as a more specific example, the volatile-memory device 220 can be balanced by allocating increased number of banks or allocate banks that are located closer to the bus or processor for the PM portion 230 to accommodate the PM mode 202. The memory configuration profile 242 for controlling or configuring the volatile-memory device 220 can further similarly increase the effectiveness or reliance on the PM portion 230 for balancing based on the memory requirement 250 associated with heavier reliance on immediate access of memory or data in comparison to capacity requirements.

Also as a more specific example, the memory configuration profile 242 can further balance by similarly increasing or decreasing the effectiveness or reliance with number or location of allocated banks for the BW portion 234, the HWC portion 232, or a combination thereof to accommodate the block mode 204. The memory configuration profile 242 can further increase the effectiveness or reliance for the BW portion 234, the HWC portion 232, or a combination thereof based on the memory requirement 250 associated with heavier reliance on capacity in comparison to access speeds.

The controller component 206 can further utilize the smart memory driver 214 to control the storage or access of the information in the storage during operation or runtime of the computing system 100. The controller component 206 can set the bank ownership register 236 for providing control for data stored in the volatile-memory device 220 to the controller component 206 or the storage component 208.

The controller component 206 can set the bank ownership register 236 for setting the controller-ownership state 238 or the management-ownership state 240. The controller component 206 can further set the bank ownership register 236 according to the controller-ownership state 238 or the management-ownership state 240 for controlling information stored in a bank of the volatile-memory device 220.

The controller component 206 can utilize the controller-ownership state 238 and the management-ownership state 240 along with or for implementing specific copy or movement modes. For example, the controller component 206 can utilize data movement modes such as “MemcopyA” for moving data or information from the software, the memory controller, the smart memory driver 214, or a combination thereof. The “MemcopyA” mode can move the data or information to the BW portion 234 using an interface of the software, the memory controller, the smart memory driver 214, or a combination thereof for BW functions.

Also for example, the controller component 206 can utilize data movement modes such as “MemcopyB” for moving data or information from the BW portion 234 to the non-volatile memory device 222 using or through the management circuit 218 or the SOC. Also for example, the controller component 206 can utilize data movement modes such as “MemcopyB1” for moving data or information from the BW portion 234 to the HWC portion 232 using or through the management circuit 218 or the SOC.

Also for example, the controller component 206 can utilize data movement modes such as “MemcopyB2” for moving data or information from the HWC portion 232 to the non-volatile memory device 222 using or through the management circuit 218 or the SOC. The computing system 100 can further include or utilize a “PCOMMIT” instruction for guaranteeing bank ownership states switch for the volatile-memory device 220. The “PCOMMIT” instruction can eliminate memory controller out-of-order issue.

As an illustrative example, a high-level flow of block-mode data movement can be as follows: set the controller-ownership state 238 for software or memory controller to owning a specific bank, implement or execute “MemcopyA”, implement or execute “PCOMMIT”, set the management-ownership state 240 for the management circuit 218 or the SOC owning the specific bank, implement or execute “MemcopyB” or “MemcopyB1” with “MemcopyB2”, and then set the controller-ownership state 238 for the specific bank. The above example can be for a write case.

Also during the operation of the computing system 100, the computing system 100 can access the non-volatile memory device 222 using the BW portion 234 for storing and accessing information in the non-volatile memory device 222. The memory bus can enable or implement storage or access of the data or information on the non-volatile memory device 222 through indirect methods or processes. The BW portion 234 can be configured dynamically as discussed above.

Further during the operation of the computing system 100, the computing system 100 can access the MDB 216 for storing and accessing information in the non-volatile memory device 222, the volatile-memory device 220, or a combination thereof without or instead of utilizing the multiplexer 248. The request or access for the data or information for the storage component 208 or the volatile-memory device 220 therein can utilize the MDB 216 instead of without utilizing the multiplexer to directly access the DRAM.

It has been discovered that the non-volatile memory device 222 along with the volatile-memory device 220 dynamically configured and managed to include the PM portion 230, the HWC portion 232, the BW portion 234, or a combination thereof according to the smart memory driver 214 implemented in software provides for NVDIMMs that can support both the PM mode 202 and the block mode 204 with existing components, such as DRAM and Flash. It has been discovered that the dynamic configuration of the various portions can effectively move the data persistence close to the control circuit 112, such as the CPU, for performance improvement, for power saving in the big-data era, or for a combination thereof.

It has further been discovered that the locations and configurations of management circuit 218 and the MDB 216 provide improved accuracy based on solving timing issues with the management circuit 218 and the memory controller seeing different DRAM timing parameters. The management circuit 218 located between the controller component 206 and the volatile-memory device 220, the non-volatile memory device 222, and the MDB 216 can provide the ability to vary the timing or present different timing parameters. The MDB 216 located between the controller component 206 and the volatile-memory device 220, the non-volatile memory device 222, and the management circuit 218 can also provide the ability to vary the timing or present different timing parameters. Details regarding the timing issue will be discussed below.

It has further been discovered that implementation and usage of the controller-ownership state 238 and the management-ownership state 240 for processing storage and access of data in the storage component 208 provides increased usability for the storage component 208. The usage of the controller-ownership state 238 and the management-ownership state 240 can enable support of both NVDIMM-F and NVDIMM-N with existing technology, and further the ability to select, balance, and mix the characteristics of both devices into one device or circuit unit.

It has further been discovered that the memory configuration profile 242, dynamically generated based on the memory requirement 250 for configuring and managing the PM portion 230, the HWC portion 232, the BW portion 234, or a combination thereof provides increased flexibility for the storage circuit 114. The storage component 208 and the volatile-memory device 220 therein can be dynamically configured and matched according to the memory requirement 250 using the memory configuration profile 242. The dynamic configuration can be used to enable NVDIMM-F, NVDIMM-N, or a combination thereof using one NVDIMM.

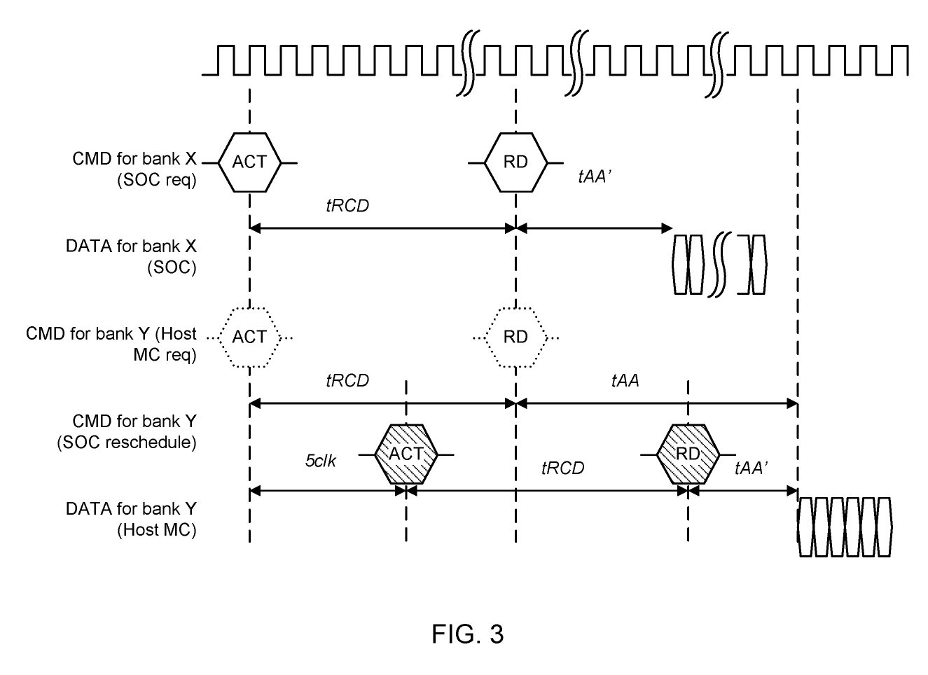

Referring now to FIG. 3 therein is shown an example timing diagram of the storage component 208 of FIG. 2. The timing diagram can be for describing timing associated with the volatile-memory device 220 of FIG. 2.

The computing system 100 of FIG. 1 can utilize the smart memory driver 214 of FIG. 2, the MDB 216 of FIG. 2, the management circuit 218 of FIG. 2, or a combination thereof to resolve the DRAM timing issue. The computing system 100 can utilize the architecture and configuration discussed above to resolve the timing issue by presenting different DRAM timing parameters for the memory controller and the management circuit 218.

As illustrated in the example of FIG. 3, “tAA′=tAA-5clk” for the volatile-memory device 220 or the DRAM. The memory controller can maintain the “tAA” without any change. When the management circuit 218 or the SOC requests a specific bank X ACT/CAS and software host memory controller or the smart memory driver 214 requests another specific bank Y ACT/CAS concurrently, the request from the software host memory controller can be delayed “5clk” with the rescheduling of the management circuit 218. The first request for Bank X will be finished by “tRCD+tAA−1clk” in the volatile-memory device 220. The second request for Bank Y will be finished by “tRCD+tAA+4clk”.

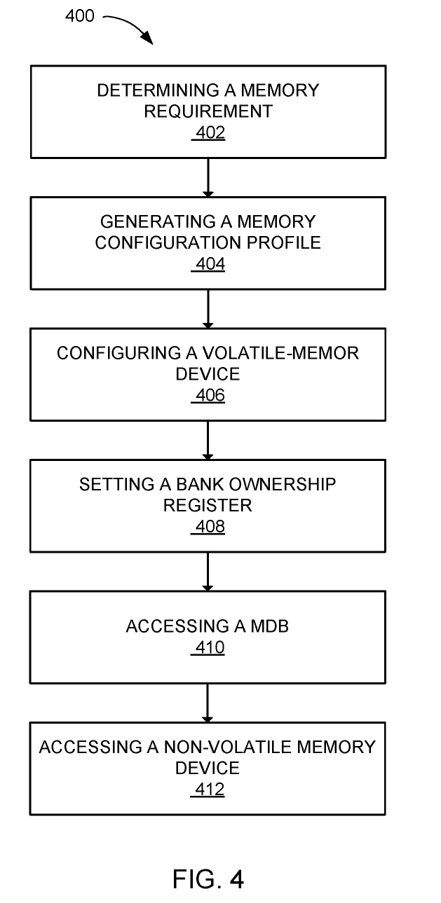

Referring now to FIG. 4, therein is shown a flow chart of a method 400 of operation of a computing system 100 of FIG. 1 in an embodiment of the present invention. The method 400 includes: determining a memory requirement for representing a user characteristic, and an application characteristic, or a combination thereof in a box 402. The method 400 can further include generating a memory configuration profile based on the memory requirement using a smart memory driver implemented in software, the memory configuration profile including a portion location, a portion size, or a combination thereof corresponding to the persistent memory portion, the hardware cache portion, and the block window portion in a box 404.

The method 400 can further include configuring a volatile-memory device based on balancing a PM portion, a HWC portion, and a BW portion within the volatile-memory device according to the memory requirement, wherein the volatile-memory device is hardware memory for storing information along with a non-volatile memory device according to a PM mode, a block mode, or a combination thereof in a box 406. The block 406 can further include configuring the volatile-memory device based on the memory configuration profile by defining within the volatile-memory device the persistent memory portion, the hardware cache portion, the block window portion, or a combination thereof according to the portion location, the portion size, or a combination thereof corresponding thereto.

The method 400 can further include operations or processes during runtime of the computing system 100. The method 400 can include setting a bank ownership register according to a controller-ownership state or a management-ownership state for controlling information stored in a bank of the volatile-memory device in a box 408.

The method 400 can also include accessing a MDB for storing and accessing information in the non-volatile memory device, the volatile-memory device, or a combination thereof without or instead of utilizing a multiplexer in a box 410. The method 400 can also include accessing the non-volatile memory device using the block window portion for storing and accessing information in the non-volatile memory device in a box 412.

The method 400 can be implemented or performed using one or more of the circuits, one or more of the components, one or more of the portions, one or more of the devices, or a combination thereof discussed above. For example, the method 400 can be implemented or performed using the control circuit 112 of FIG. 1, the storage circuit 114 of FIG. 1, or a combination thereof with the controller component 206 of FIG. 2, the storage component 208 of FIG. 2, or a combination thereof included therein as discussed above.

As a more specific example, the method or process represented in the box 402, box 404, or a combination thereof can be implemented or performed using the controller component 206. Also as a more specific example, the method or process represented in the box 406 can be implemented or performed using the smart memory driver 214 of FIG. 2, the volatile-memory device 220 of FIG. 2, the management circuit 218 of FIG. 2, or a combination thereof.

Also as a more specific example, the method or process represented in the box 408 can be implemented or performed using the smart memory driver 214, the volatile-memory device 220, the non-volatile memory device 222 of FIG. 2, the management circuit 218, or a combination thereof. Also as a more specific example, the method or process represented in the box 410 can be implemented or performed using the controller component 206, the volatile-memory device 220, the non-volatile memory device 222, the management circuit 218, or a combination thereof. Also as a more specific example, the method or process represented in the box 412 can be implemented or performed using the controller component 206, the volatile-memory device 220, the non-volatile memory device 222, the management circuit 218, the MDB 216 of FIG. 2, or a combination thereof.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a storage component including a volatile-memory device and a non-volatile memory device configured to enable persistent storage of information along with block-oriented mass storage of information; and
a controller component, coupled to the storage component, configured to implement a smart memory driver configured to dynamically manage the volatile-memory device including managing a persistent memory (PM) portion, a hardware cache (HWC) portion, a block window (BW) portion, or a combination thereof within the volatile-memory device.

2. The system as claimed in claim 1 wherein the storage component includes a memory data buffer (MDB), coupled to the volatile-memory device, the non-volatile memory device, and the controller component, configured to manage data exchange between the volatile-memory device, the non-volatile memory device, the controller component, or a combination thereof.

3. The system as claimed in claim 1 wherein the storage component includes a management circuit, coupled to the volatile-memory device, the non-volatile memory device, and the controller component, configured to control the volatile-memory device and the non-volatile memory device according to the controller component.

4. The system as claimed in claim 1 wherein the controller component is configured to set a bank ownership register for providing control for data stored in the volatile-memory device to the controller component or the storage component.

5. The system as claimed in claim 1 wherein:
the controller component is configured to determine a memory configuration profile including a portion location, a portion size, or a combination thereof for configuring the persistent memory (PM) portion, the hardware cache (HWC) portion, the block window (BW) portion, or a combination thereof for the volatile-memory device; and
the storage component includes the volatile-memory device including the persistent memory (PM) portion, the hardware cache (HWC) portion, the block window (BW) portion, or a combination thereof configured according to the portion location, the portion size, or a combination thereof corresponding thereto.

6. The system as claimed in claim 1 wherein:
the controller component includes the smart memory driver implemented in software;
the storage component is a non-volatile dual in-line memory module (NVDIMM) including:
a memory data buffer (MDB), coupled to the volatile-memory device and coupled to the controller component through a data path, configured to manage data exchange between the volatile-memory device, the non-volatile memory device, the controller component, or a combination thereof,
a management circuit implemented as system on chip (SOC), coupled to the non-volatile memory device, the memory data buffer (MDB), and the controller component, configured to control the volatile-memory device and the non-volatile memory device according to the controller component, and
the volatile-memory device implemented as a dynamic random access memory (DRAM).

7. The system as claimed in claim 6 wherein the volatile-memory device includes the block window (BW) portion dynamically configured for providing access to the non-volatile memory device for the controller component.

8. The system as claimed in claim 6 wherein the memory data buffer (MDB) is connected to all instances of the data path for the storage component.

9. The system as claimed in claim 6 wherein the storage component is configured to utilize the memory data buffer (MDB), the management circuit, or a combination thereof to provide access to the volatile-memory device without a multiplexer.

10. The system as claimed in claim 6 wherein:
the persistent memory (PM) portion is configured to implement a persistent memory (PM) mode for continually providing access to data therein after the end of a process;
the hardware cache (HWC) portion is configured to be owned by the management circuit for supporting the non-volatile memory device; and
the block window (BW) portion is configured to provide an interface for the non-volatile memory device.

11. A method of operation of a computing system comprising:
determining a memory requirement for representing a user characteristic, an application characteristic, or a combination thereof; and
configuring a volatile-memory device based on balancing a persistent memory (PM) portion, a hardware cache (HWC) portion, and a block window (BW) portion within the volatile-memory device according to the memory requirement, wherein the volatile-memory device is hardware memory for storing information along with a non-volatile memory device, according to a persistent memory (PM) mode, a block mode, or a combination thereof.

12. The method as claimed in claim 11 further comprising:
generating a memory configuration profile based on the memory requirement using a smart memory driver, the memory configuration profile including a portion location, a portion size, or a combination thereof corresponding to the persistent memory (PM) portion, the hardware cache (HWC) portion, and the block window (BW) portion; and
wherein:
configuring the volatile-memory device includes configuring the volatile-memory device based on the memory configuration profile by defining within the volatile-memory device the persistent memory (PM) portion, the hardware cache (HWC) portion, the block window (BW) portion, or a combination thereof according to the portion location, the portion size, or a combination thereof corresponding thereto.

13. The method as claimed in claim 11 further comprising accessing the non-volatile memory device using the block window (BW) portion for storing and accessing information in the non-volatile memory device.

14. The method as claimed in claim 11 further comprising accessing a memory data buffer (MDB) for storing and accessing information in the non-volatile memory device, the volatile-memory device, or a combination thereof without or instead of utilizing a multiplexer.

15. The method as claimed in claim 11 further comprising setting a bank ownership register according to a controller-ownership state or a management-ownership state for controlling information stored in a bank of the volatile-memory device.

16. A non-transitory computer readable medium including instructions for a computing system comprising:
determining a memory requirement for representing a user characteristic, an application characteristic, or a combination thereof; and
configuring a volatile-memory device based on balancing a persistent memory (PM) portion, a hardware cache (HWC) portion, and a block window (BW) portion within the volatile-memory device according to the memory requirement, wherein the volatile-memory device is hardware memory for storing information along with a non-volatile memory device, according to a persistent memory (PM) mode, a block mode, or a combination thereof.

17. The non-transitory computer readable medium as claimed in claim 16 further comprising:
generating a memory configuration profile based on the memory requirement using a smart memory driver, the memory configuration profile including a portion location, a portion size, or a combination thereof corresponding to the persistent memory (PM) portion, the hardware cache (HWC) portion, and the block window (BW) portion; and
wherein:
configuring the volatile-memory device includes configuring the volatile-memory device based on the memory configuration profile by defining within the volatile-memory device the persistent memory (PM) portion, the hardware cache (HWC) portion, the block window (BW) portion, or a combination thereof according to the portion location, the portion size, or a combination thereof corresponding thereto.

18. The non-transitory computer readable medium as claimed in claim 16 further comprising accessing the non-volatile memory device using the block window (BW) portion for storing and accessing information in the non-volatile memory device.

19. The non-transitory computer readable medium as claimed in claim 16 further comprising accessing a memory data buffer (MDB) for storing and accessing information in the non-volatile memory device, the volatile-memory device, or a combination thereof without or instead of utilizing a multiplexer.

20. The non-transitory computer readable medium as claimed in claim 16 further comprising setting a bank ownership register according to a controller-ownership state or a management-ownership state for controlling information stored in a bank of the volatile-memory device.
